(19) United States
(12) Patent Application Publication
(10) Pub. No.: US 2006/0245815 A1
(43) Pub. Date: Nov. 2, 2006

(54) Wallet card writing instrument

(76) Inventor: Gregory Anton Chakmakian, Northridge, CA (US)

Correspondence Address: GREGORY CHAKMAKIAN, 19131 GERMAIN ST., NORTHRIDGE, CA, 91326, US

(21) Appl. No.: 11/120,066

(22) Filed: May 2, 2005

(51) Int. Cl. B43K 23/02

(52) U.S. Cl. 401/131; 401/195

(57) ABSTRACT

A writing instrument with an outer element (20, 22) that extends away from a pen (24, 26) and pen receptacle (20) into a substantially flat card like base (22). Which then can be adhered to a second object or stand alone as a card like pen.

### CROSS REFERENCE TO RELATED PATENTS

Not Applicable

### FEDERALLY SPONSORED RESEARCH

Not Applicable

### SEQUENCE LISTING OR PROGRAM

Not Applicable

### BACKGROUND OF INVENTION

1. Field of Invention

This invention relates to wallet sized writing instruments used as a means to display images.

2. Prior Art

The need for a pen which is convenient to carry on the person always and the need for an effective way of advertising are well known and recognized.

Writing instruments have traditionally been round or polygonal with a clip so as to carry on your person in a pocket, on a shirt sleeve, ect., but very often one forgets to carry a traditional pen at all times. This makes them inconvenient, but necessary. Likewise the very idea of the semi-permanence and necessity of a writing instrument has sparked numerous ideas pertaining to both promotion (product, logo, slogan, business, ect.) and more convenient ways to carry a pen.

In U.S. Pat. No. 5,086,577 issued to Abernethy in 1992 the problem of advertising to a pen is approached as a novelty with a swinging card attached to a full sized pen. The invention is not truly practical to carry on your person nor is it distinguished enough to keep on a business desk.

Likewise U.S. Pat. No. 4,787,161 issued to Feng in 1988 while capable of placing on a desk, is cumbersome to carry around and doesn't sufficiently address the need of cheep efficient advertising.

Also in the marketplace their are pens with advertising printed directly on the pen. These pens are convenient, but still are constricted by the constraints of the traditional ball pen, namely not being convenient to carry said pen with advertising on your person always.

Also several types of portable pens have been invented. In U.S. Pat. No. 4,815,880 issued to Sekiguchi in 1989 pens carved out of a card lack practicality. Each pen must be snapped in and out of the card which requires consciences attention so as to take the pens out of the wallet snap them out and then when done properly fit then back into place.

In U.S. Pat. Nos. D302,985 and 5,897,261 issued to Vinck in 1989 and Goetz in 1999 respectively, both pens need to be removed from a card pocket before use. Also caps conceivably must be removed and then replaced when done. And finally, all these compact pens would require something other than traditional pen dynamics, which calls for a 3/16 inch in diameter ink well which is substantially larger than an card pocket, making all these pens cumbersome and very tight fitting in use. If manufactured to fit comfortably in a wallet all would be wafer like and uncomfortable.

### OBJECTS AND ADVANTAGES

Accordingly the objects and advantages of my present invention are:

a) A compact wallet sized pen which can be produced using similar elements as a traditional writing instrument.

b) A pen which can easily be inserted into a wallet.

c) A compact pen which can be slid in and out of a wallet with relative ease and simplicity.

d) A compact pen which can extend to fit any normal sized hand.

e) A pen design which can be incorporated into a plastic credit card or be affixed to a card of some other substance whereby pen can become a means to display images.

f) A convenient means of displaying images that will be kept because of the necessity and semi-permanence of a writing instrument.

Further objects and advantages are to provide a pen which will be convenient to carry in your person always, easy to distribute, inexpensive to manufacture, and a pen that is simple and convenient to use. Still further objects and advantages will become apparent from a consideration of the ensuing description and drawings.

### SUMMARY

In accordance with the present invention a writing instrument comprising of an outer element which is flat on one side and has a receptacle for an inner pen. Flat surface shall extend away from the receptacle to create a base. Said flat surface shall also be thin enough to either fit in a card pocket or be adhered to another object without substantially altering the other object.

### DRAWINGS—FIGURES

FIG. 1 shows the back view of the assembled writing instrument as a one piece card.

FIG. 2 shows the back view of the assembled writing instrument.

FIG. 3 shows the side view of the writing instrument as a one piece card.

FIG. 4 shows the side view of the writing instrument, to be adhered to a second object.

FIG. 5 shows the inner writing instrument in the closed position.

FIG. 6 shows the inner writing instrument in an extended or open position.

FIG. 7 shows a detail of the inner pen's cover at the point where the ink well enters.

FIG. 8 shows an isometric detail of the inner pen in a fully open position.

FIG. 9 shows an isometric exploded parts assembly view of the writing instrument.

FIG. 10 shows a front view of the writing instrument with images displayed.

FIG. 11 shows a front view of the inner pen being removed by a finger from the outer element.

FIG. 12 shows the assembled writing instrument inside a wallet card pocket.

### DRAWINGS—REFERENCE NUMERALS

20 pen cavity (outer element)
22 base of outer element
24 ink well
26 ink well cover
28 pinched side
30 locking ridge
32 locking groove

### DETAILED DESCRIPTION

### Preferred Embodiment—FIGS. 1, 2, 3, 4

The preferred embodiment of the present invention, wallet card writing instrument is illustrated in FIGS. 1 (back view), 2 (back view), 3 (side view), and 4 (side view with card on which to be adhered). The writing instrument consists of three parts: an inner inkwell with writing element 24, an outer slidable cover 26 which protects the inkwell while in the wallet, and an outer element 20, 22 which serves as cap to the instrument.

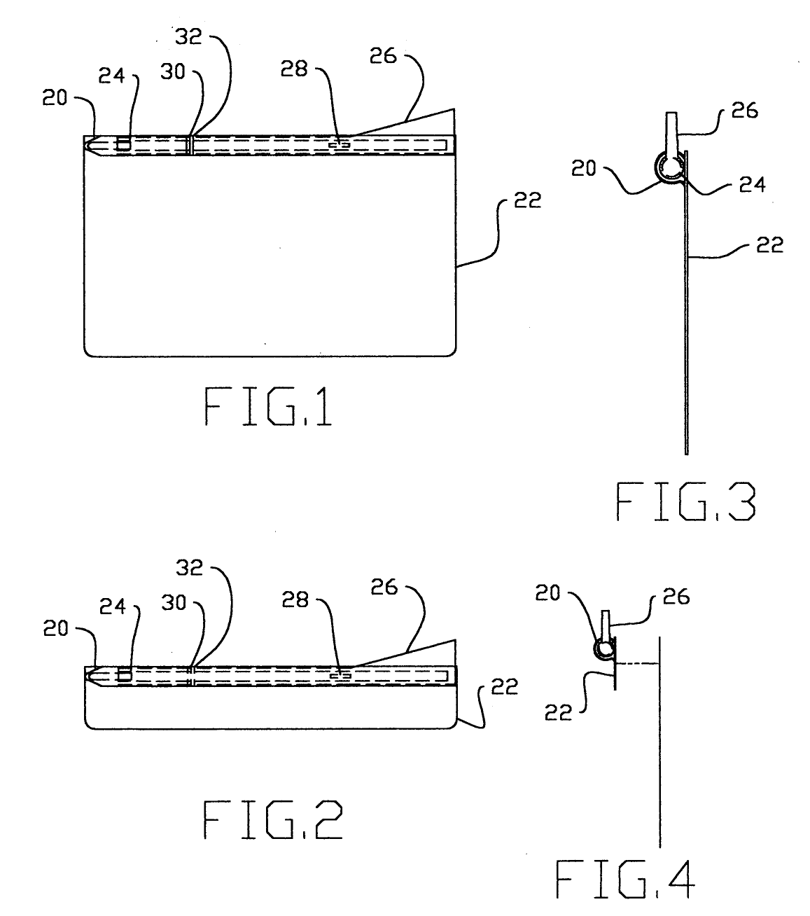

In FIG. 1 the outer element 20,22 has an extended base 22 and measures the standard size of a credit card about 3.5 inches by 2 inches. Ideally it is made out of plastic, but can be made out of any suitable material. The inner writing instrument or pen 24,26 sits snugly inside the a cavity 20 formed within the outer element 20,22 itself, as further demonstrated in FIG. 3. Also a ridge, groove system 30,32 can be incorporated into the design to keep the pen 24,26 locked into place when not in use. The pen 24,26 need not be limited to the male female design, another embodiment could be a dock for a pen which snaps snugly into place.

FIGS. 2 and 4 illustrate how the outer element's base 22 can be shortened so as to achieve an adhere able flat side that will not substantially alter the use or dynamics of the subject which will accept the writing instrument, such as a business card.

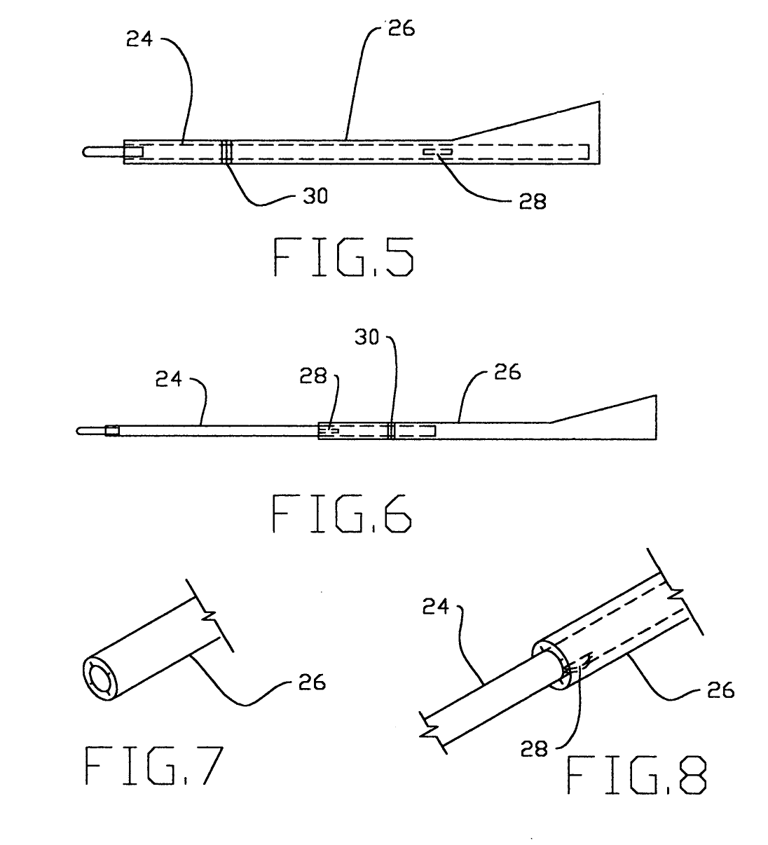

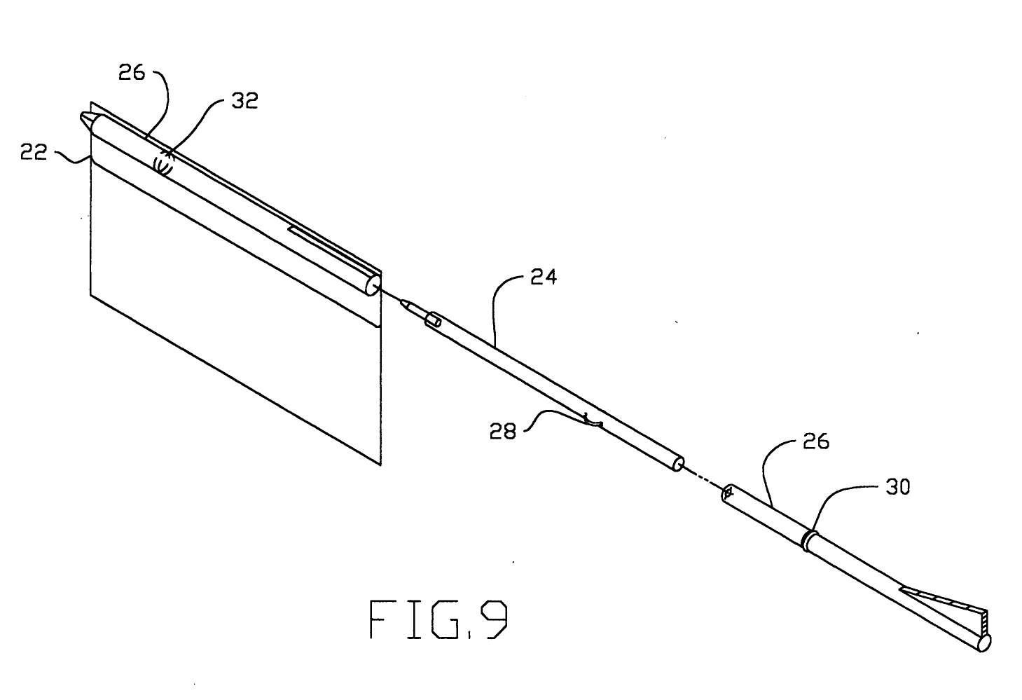

Typically standard ink wells 24 are less than 3/16 inch in diameter and normally have two parallel pinched sides 28 to facilitate the use of a spring. The present invention incorporates this technology as more clearly illustrated in FIGS. 6 and 8.

### Pen Operation—FIGS. 5, 6, 7, 8

The inner writing instrument or pen 24,26 should be manufactured so as to ease the use of the pen 24,26. FIG. 5 illustrates the pen 24,26 in the fully closed position (unextended). Incidentally, notice the ridge 30, now exposed, which can lock the pen 24,26 into the outer element 20,22.

FIG. 6 is the pen 24,26 fully extended. It's important to notice the two pinched sides 28 that facilitate a smooth sliding system during the extension process and how they serve as a kind of lock to stop the slidable cover 26 when the pen 24,26 is fully extended, detailed in FIG. 8. FIG. 7 is a detail of the pen cover 26 at the end where the ink well 24 enters. This end serves as both a stopper for the pinched sides 28 and as a locking mechanism for the closed inner writing instrument 24, 26. This end shall be made of an sufficiently pliable material which can when slotted accept the ink well 24, last through the sliding process and finally lock slightly over the end of the ink well 24 to hold the pen 24,26 closed.

FIG. 9 illustrates the wallet card writing instrument broken down into its three parts. The groove 32 for the ridge on the pen cover 30 is represented by hidden lines.

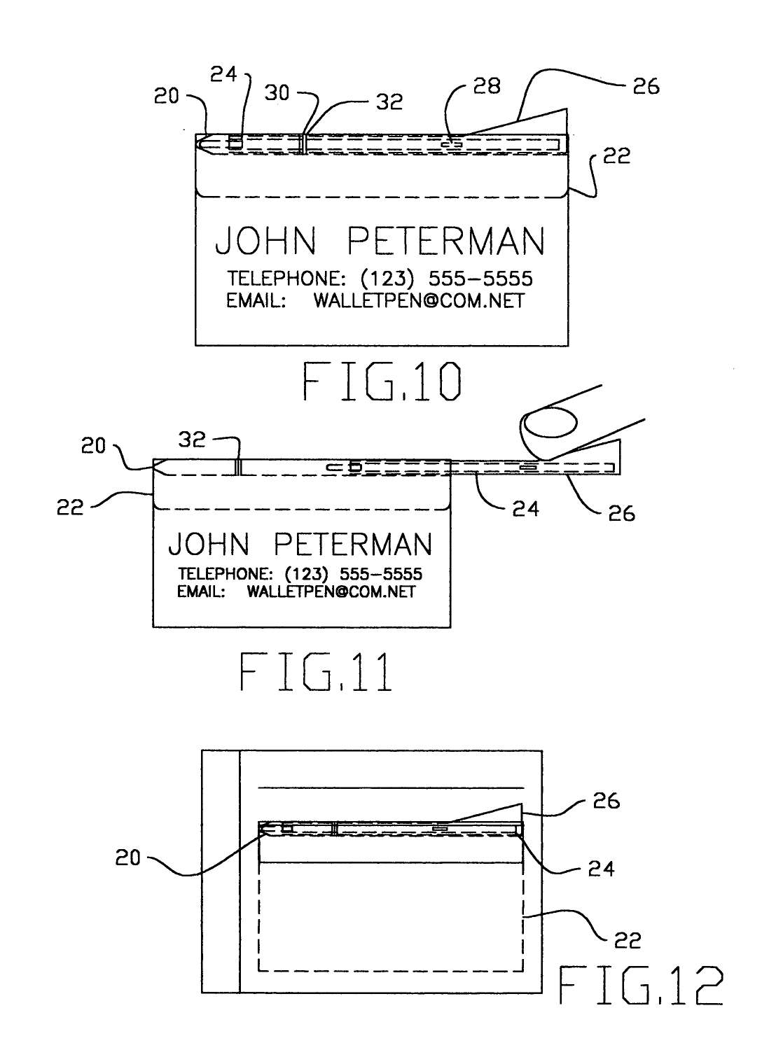

### Embodiment Views—FIGS. 10, 11, 12

There are many ways in which the present invention can be used. In FIGS. 10, 11, 12 some uses and operations are illustrated.

In FIG. 10 the front view of the present invention is shown. Images displayed on the front of a card is added as a possible use of the writing instrument. FIG. 11 illustrates the slidability of the inner pen 24, 26. A finger demonstrates the ease of operation of the wallet card writing instrument.

FIG. 12 illustrates the wallet card writing instrument inside the card pocket of a wallet. Clearly the wallet card writing instrument takes up no more room than a standard business or credit card. It can be carried comfortably inside a wallet, and for the life of the pen it won't be discarded or forgotten not on person. Its simplicity of design and its use of traditional manufacturing standards, make it superior to the many inventions that came before it. Utility, ease of use, and affordability are the aims of the wallet card writing instrument. It is salable and effective as a means of advertisement and its uses need not stop there. The wallet card writing instrument offers assistance to all people that ever found themselves without a pen and likewise it offers help to anyone trying to reach the public with a message.

Although the description above contains specifics, these should not be construed as limiting the scope of the invention, but providing illustrations of some of the presently preferred embodiments of this invention. For example the instrument can be adhered to a pad of paper, have other shapes, of different locking mechanisms, ect.

Thus the scope of the invention should be determined by the appended claims and their legal equivalents, rather than the examples given.

I claim:

1. A writing instrument comprising of an outer element which is substantially flat on one side, extends predominantly away from a pen receptacle, and is attached to said pen receptacle, to form a thin card like base, plus an inner removable pen to be received into said pen receptacle.

2. The writing instrument of claim 1 where the said outer element is used as a means to display images.

3. The writing instrument of claim 1 where said outer element is adhered to a card substantially equal in size as a business card.

4. The writing instrument of claim 1 where said outer element base is substantially equal in size as a standard credit card.

5. The writing instrument of claim 1 where said inner pen has a cover.

6. The writing instrument of claim 1 where said cover of inner pen is extendable.

7. The writing instrument of claim 1 where said inner pen has a means of locking said pen into said outer element.

8. A writing instrument comprising of:
a) an outer element which is substantially flat and thin on one side.
b) said outer element extending away from a pen receptacle which is part of said outer element.
c) an inner pen to be received to said outer element and can be used as a removable writing instrument.

9. The writing instrument of claim 8 with said flat side of outer element in the shape of a traditional credit card.

10. The writing instrument of claim 8 with said flat side of outer element used as a surface to be adhered to a second object.

11. The writing instrument of claim 8 with said outer element used as a means to display images.

12. The writing instrument of claim 8 where said displayed images are text.

13. The writing instrument of claim 8 where said removable writing instrument is of the ball point type.

14. The writing instrument of claim 8 where said flat side of outer element extends all around said pen receptacle.

15. A method of retaining a writing instrument, comprising:
a) providing a writing instrument comprising a flat and thin outer element attached to a pen receptacle and extends away from said pen receptacle to form a card, and an inner pen towards one end of said card which is received in the said pen receptacle.
b) providing a card pocket.
c) inserting said writing instrument into said card pocket where said inner pen and pen receptacle do not enter said card pocket but stay out and above card pocket opening.

16. The method of claim 15 wherein said thin and flat outer element is attached to a business card.

17. The method of claim 15 wherein images are displayed on said card.
